(19) United States
(12) Patent Application Publication
(10) Pub. No.: US 2015/0000699 A1
(43) Pub. Date: Jan. 1, 2015

(54) ORAL HYGIENE DEVICE AND METHOD OF USING THE SAME

(71) Applicant: Aaron Kelsey, La Quinta, CA (US)

(72) Inventor: Aaron Kelsey, La Quinta, CA (US)

(21) Appl. No.: 14/318,357

(22) Filed: Jun. 27, 2014

Related U.S. Application Data
(60) Provisional application No. 61/840,372, filed on Jun. 27, 2013.

(51) Int. Cl. A61C 19/06; A46B 11/00

(52) U.S. Cl. CPC A61C 19/063; A46B 11/0013; A46B 11/0062; A46B 2200/108
USPC 134/6; 15/104.94

(57) ABSTRACT

The present invention provides for an oral hygiene device and methods of using the device, the device comprises a body comprising an open end, a closed end and a reservoir, wherein the reservoir comprises an oral cleaner; and an applicator assembly, comprising a cap removably attached to the body so that the cap ensures closure of the body and an applicator connected to the cap by an axial rod. In a further embodiment the reservoir is contained within the body and comprises an open end and a closed end coincident with the body.

### CROSS-REFERENCE TO RELATED APPLICATIONS

The present Application claims the benefit of U.S. Provisional Patent Application No. 61/840,372 titled “Oral Hygiene Device and Method of Using the Same” filed Jun. 27, 2013, the contents of which are incorporated in this disclosure by reference in their entirety

### BACKGROUND

Oral hygiene is not only important for cosmetic reasons but poor dental hygiene can cause tooth decay, cavities, gingivitis, and gum disease, all of which can lead to heart disease. The most common routine for maintaining oral health is teeth brushing. Most people brush their teeth at least twice a day to remove debris, bacteria or other harmful germs, and create fresh breath. Additionally, regular tooth brushing prevents tartar and plaque. Flossing is another way to improve oral health. However, for some people flossing is too difficult whether it takes too long or it is too difficult for dexterity reasons, there are many reasons why people do not floss on a regular basis.

People with receding gums or braces cannot reach all the spaces and bacteria can accumulate by brushing and flossing alone. Often times, small particles of food are left between the teeth feeding the bacteria. This can lead to enlarging spaces caused by bacterial growth, resulting in gingivitis and periodontitis. Inter-dental brushing can be highly effective in removing this food.

Interdental brushing or proxy brushing is another method for cleaning teeth. Interdental brushes are small wires topped with bristles (resembling a pipe cleaner), attached to plastic handles, that clean between teeth. Interdental brushes come in a variety of sizes to fit between spaces in different people's teeth. Some people need more than one size because the spacing between their teeth varies. Interdental flossing or brushing makes cleaning between the teeth easier and more effective in many cases. Similar to a tooth brush, unless an interdental brush is used in connection with a cleaning solution or paste, the user is “dry” brushing their teeth.

Even with all these cleaning techniques, many people are still not compliant or diligent in cleaning their teeth. In order to maintain good oral health people need to practice good dental hygiene on a regular basis. Furthermore, people are busy and often times are not in a position where they have the necessary tools or opportunity to clean their teeth. Presently, there is no way to effectively deliver a precise placement of an oral cleaner or medication in a problem area or clean teeth “on the go”.

For the foregoing reasons, there is a need for an oral hygiene device that is user friendly, compact, mobile, and has the built-in ability to precisely deliver an oral cleaner or medicament while providing a deeper clean or sealant in between professional cleanings thereby preventing the buildup of harmful bacteria or plaque.

### SUMMARY

A device having features of the present invention satisfies this need. The device comprises a body, comprising an open end, a closed end and a reservoir, wherein the reservoir comprises an oral cleaner; and an applicator assembly. The applicator assembly comprises a cap, removably attached to the body so that the cap ensures closure of the body and an applicator connected to the cap by an axial rod. In a further embodiment the reservoir is contained within the body and comprises an open end and a closed end coincident with the body.

As disclosed herein, the device has been configured to combine a dental tool and a cleaning substance. The combination of these two items in a mobile, compact, single unit will make it easier for people to clean their teeth. The applicator portion of the device is a tool designed to improve oral hygiene. The cleaning substance is located in the reservoir contained within the body of the device. When the applicator is inserted inside the reservoir, it is immersed in the oral cleaner. When the applicator is removed from the reservoir, it has the solution or paste on its surface. The user then uses the applicator or tool as they would in normal use. The oral cleaner that is on the applicator will then be applied to the user's teeth and/or gums as the user is cleaning the teeth. The oral cleaner eliminates more bacteria than dry brushing alone. The cleaning solution or paste will also leave a residue on the surface of the teeth and gums keeping the oral cavity healthier in between cleanings. This mobile capability of cleaning the teeth results in greatly improved oral health.

In another embodiment the applicator of the oral hygiene device is in the form of an interdental brush. The interdental brush is desirable because it is small and highly effective in the removal of plague and food particles from hard to reach interproximal spaces. Therefore in a preferred embodiment the applicator assembly comprises a bristle portion wherein the bristle portion is 0.2 mm to 5.0 mm.

In another embodiment the oral cleaner is a solution, paste or both. The oral cleaner can also be a medicament.

By having the applicator pre-soaked with an oral cleaner the user simply removes the applicator from the reservoir and uses it on their teeth and gums. Because the brush is flexible in nature, it reverts to its original size for repeat usage after passing through an interdental space. The brush removes plaque as it squeezes between sides of teeth. The interdental brush is also able to deliver a precise placement of an oral cleaner or medicament in places that are most difficult to reach. Post use, the user can either place the brush back into the reservoir or rinse the brush with water before placing the brush back into the container.

In another embodiment, the applicator can be attached to the reservoir and body. In this configuration the device further comprises a hollow shaft having a proximal end and a distal end the proximal end configured to receive oral cleaner from the reservoir and the distal end having an applicator; and a cap sized and dimensioned to fit over the applicator to securely engage the body.

The cap can be placed over the applicator to prevent the oral cleaner from leaking from the reservoir. The applicator being enclosed in the cap also protects the applicator from external contamination between uses. The body housing the reservoir is flexible so that by applying pressure to the body, the cleaning solution travels up through the applicator towards the application area. The more the user squeezes the body the more oral cleaner is released on the applicator.

In another embodiment the device comprises a body comprising a first reservoir and a second reservoir contained with body, each reservoir comprising an open end and a closed end coincident with the body; an applicator assembly comprising a cap removably attached to the body so that the cap ensures closure of the body and an applicator connected to the cap by an axial rod; and a lid for covering the second reservoir. In this configuration the reservoirs can have two different oral cleaners or alternatively one reservoir can house an oral cleaner while the other reservoir is filled with water. The water is used to clean the applicator post use. The reservoir containing the water can be emptied when the water is dirty and refilled with clean water.

In still another embodiment the device comprises a body comprising a first reservoir and a second reservoir contained with body, each reservoir comprising an open end and a closed end coincident with the body; and a first applicator assembly and a second applicator assembly, each applicator assembly comprising a cap removably attached to the body so that the cap ensures closure of the body and an applicator connected to the cap by an axial rod. When the device is configured with two applicators, the applicators can be different. For example, one applicator can be an interdental brush while the other applicator is a sponge Like the embodiment above, the reservoirs can optionally have different oral cleaners as well.

In another embodiment, the device is a compact, mobile oral hygiene device. The device can be used as part of the user's regular dental hygiene routine or it can be used in situations when the user cannot brush and floss. For example, if the user were out to dinner, at work or in their car, they can use the device for a quick cleanup. In use, the user removes the applicator assembly or cap, applies the applicator to the mouth area, and replaces the cap or applicator assembly when finished.

In still another embodiment, the applicator is replaceable. Whether the applicator is part of the applicator assembly or alternatively attached to the body it can be removed and replaced with a new applicator. The removable feature allows the user to remove an “old” applicator and replace it with a “new” one. Additionally, a user may require various size brushes to accommodate the make-up of their teeth. Furthermore, the applicators, brushes and the bristle properties of the brushes can vary. When the applicator is removable, it will extend the life of the oral hygiene device.

In yet another embodiment, the oral hygiene device and its parts can be combined in a system. The system comprises a body having a reservoir, and applicator assembly or caps, additional applicators and an oral cleaner.

In still another embodiment, the device having the features of the present invention is inexpensive to manufacture, but is durable and effective in design. Lastly, the device should be easy to use in any setting. The oral hygiene device emphasizes improved oral health by offering a simple solution that will improve dental cleaning compliance.

### DRAWINGS

The following drawings form part of the present specification and are included to further demonstrate certain aspects of the present invention. The invention may be better understood by reference to one or more of these drawings in combination with the detailed description of specific embodiments presented herein where:

FIG. 1 illustrates one embodiment of the device in an open configuration;

FIG. 2 illustrates another embodiment of the device in an open configuration;

FIG. 3 illustrates another embodiment of the device similar to the device as illustrated in FIG. 2;

FIG. 4 illustrates the removal capability of the applicator to the body or applicator assembly;

FIG. 5 illustrates the device in a closed configuration;

FIG. 6A and 6B illustrate another embodiment of the device; and

FIG. 7 illustrates an oral cleaning system.

### DESCRIPTION

The present invention is directed toward a device and methods for using the same. In the following description, numerous specific details are set forth to provide a more thorough description of embodiments of the invention. It will be apparent, however, to one skilled in the art, that the embodiments of the present invention may be practiced without these specific details. In other instances, well known features have not been described in detail so as not to obscure the invention. Even though this invention describes a device using an interdental brush, it is also contemplated the device can also be used with a tooth brush, interproximal brush, floss brush, toothpick, rubber spatula, scraper or any instrument that can be used on the teeth, gums or oral cavity.

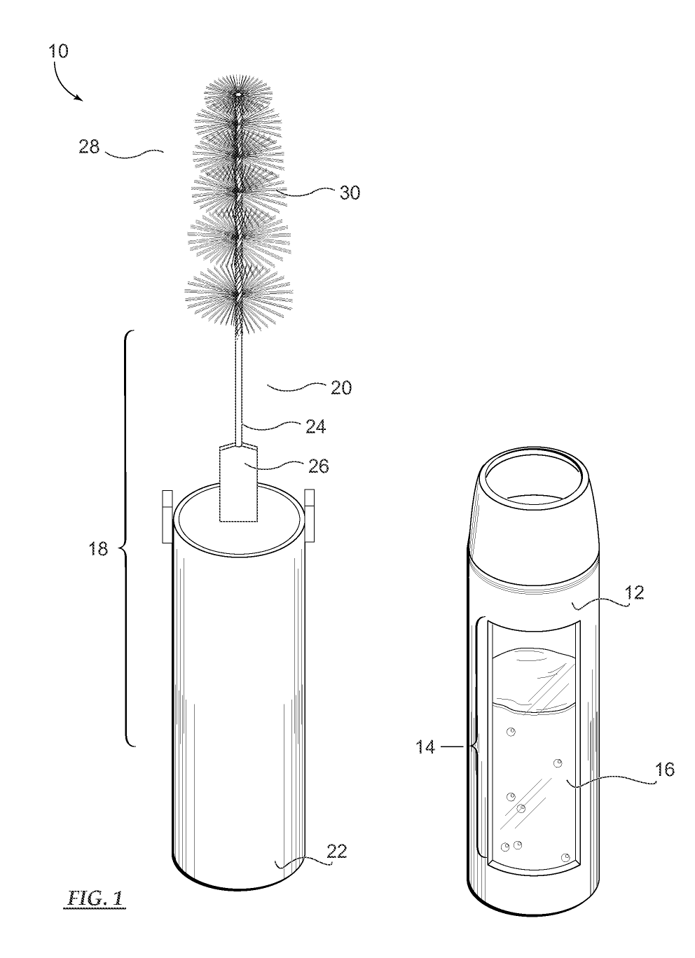

A first form of the device 10 according to the invention is generally shown in FIG. 1. The device 10 has an elongated body 12 with an open end, a closed end, a reservoir 12 that comprises an oral cleaner 16 and an applicator assembly 18. The reservoir 14 has an open end coincident with the open end of the body 12, and a closed end. The applicator assembly 18 is removably attached to the body 12. The applicator assembly 18 comprises an applicator 20 adapted for applying an oral cleaner 16 and a cap 22. The applicator 20 is connected to the cap 22 with an axial rod 24.

The body 12 and applicator assembly 18 can be made of thermoplastic or other materials know in the art.

The axial rod 24 has a distal end 26 and an opposed application end 28. The distal end 26 of the axial rod 24 is attached to the cap 22. The axial rod 24 can be made of any materials known in the art however in a preferred embodiment the axial rod 24 is made of a plastic material. The proximal end or opposed application end 28 can comprise any means useful for applying or using an oral cleaner 16 on the teeth or gums, for example a sponge, cloth or spatula. The application end 28 can also be any instrument useful for improving oral health including a brush, floss, pick or the like.

In a preferred embodiment, the application end 28 has a bristle portion 30. The bristle portion 30 can extend radially outwardly from the surface of the application end 28 and can be made of plastic filaments or synthetic fibers.

In a most preferred embodiment, the applicator 20 and application end 28 are in the form of an interdental brush. Interdental brushes are known in the art and some examples are offered by Oral B®, Gum® and TePe®. An interdental brush is useful because of its effectiveness, compact size, flexibility and cost to manufacture. An interdental brush is comprised of a wire and bundles of filaments. Alternatively, interdental brushes can be composed of a plastic shaft with a bristle portion on the end. The interdental brush is used to remove plaque and tartar which accumulates between the teeth by pushing and pulling the brush inserted into the teeth. Generally, an interdental brush is composed of wire or thin plastic so that the brush can be inserted into small spaces namely between teeth. Interdental brushes are different from toothbrushes because the bristle portion surrounds circumference of the wire or thin plastic. The brush size or bristle portion generally ranges in size from 0.4 mm to 1.5 mm. Therefore in a preferred embodiment the bristle portion 30 is between 0.1 mm and 5.0 mm.

The distal end 26 of the applicator 20 is coupled to the cap 22, so that the cap 22 also functions as a handle for the user to grasp the device 10. The cap 20 can have an internal screw thread intended to engage the external screw thread on the outer surface of the body 12. Alternatively, any means known in the art can be used to secure the cap 22 and applicator assembly 18 to the body 12. The application end 28 is sized and dimensioned to be inserted within the reservoir 14 so that the bristle portion 30 immersed in the oral cleaner 16 contained within the reservoir 14.

The oral cleaner 16 contained within the reservoir 14 can be any fluid, solution, gel, paste, topical, cream that improves oral health, cosmetic appearance, provides medication or relief. The device 10 can be categorized based on the substance inside the reservoir 14. For example, a kids product the can contain a fluoride substance to help prevent cavities. A cosmetic product can have a whitening substance which may include such ingredients as carbamide peroxide, hydrogen peroxide, calprox, hydrated silica, polyvinylpyrrolidone , potassium nitrate, sodium bicarbonate, sodium monofluorophosphate, sodium tripolyphosphate or strontium chloride.

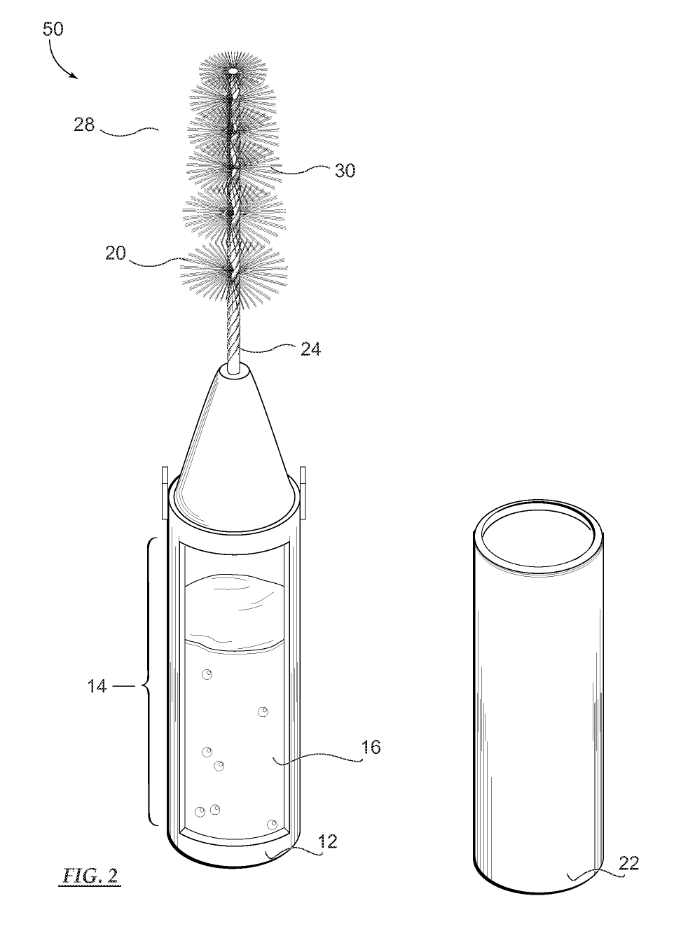

FIG. 2 illustrates an alternative embodiment of the device 50 wherein the distal end 26 of the applicator 20 is attached to the body 12. The interior of the axial rod 24 is hollow to allow fluid in the reservoir 16 to travel from the reservoir 16 up through the axial rod 24 toward the application end 28 of the applicator 20. In this embodiment, the body 12 is constructed such that the more pressure that is applied to the body 12 the more fluid is released on the application end 28. The shape of the body 12 is not important but can be configured to fit ergonomically in the hand of the user. This will make the oral hygiene device 50 easier to handle in use.

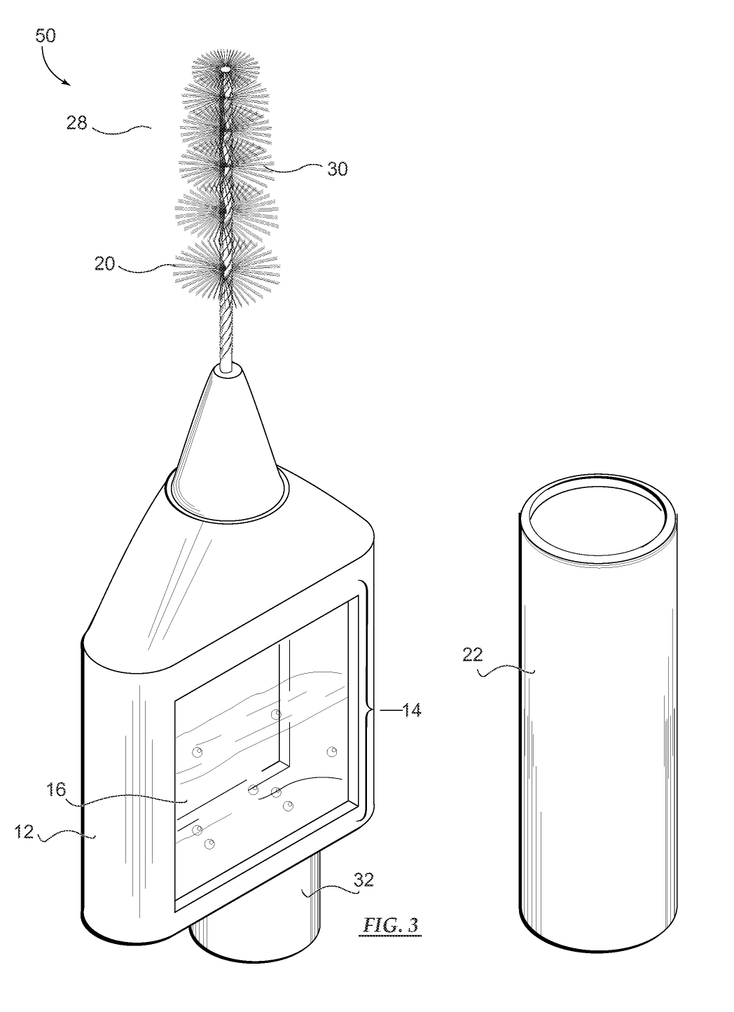

FIG. 3, is configured like FIG. 2 but shows an alternative shape of a body 12 that is common for some interdental brushes. Devices 50 configured in this manner have a cap 22 configured to ensure that the oral cleaner 16 does not leak from the reservoir 14 and protects the application end 24 from contamination when not in use. The cap 22 can be attached to the body 12 by a screw mechanism, or any other locking connection to securely fasten the cap 22 to the body 12. Optionally, the bottom portion of the body 12 can have a raised portion 32 that is the same size or compliments the hollow portion of the cap 22. When the cap 22 is removed from the body 12, it is placed on the raised portion 32 so it will not be lost or misplaced. When the user is finished using the applicator 20, the cap 22 is removed from the raised portion 32 and placed once again over the applicator 20 securely engaging the body 12.

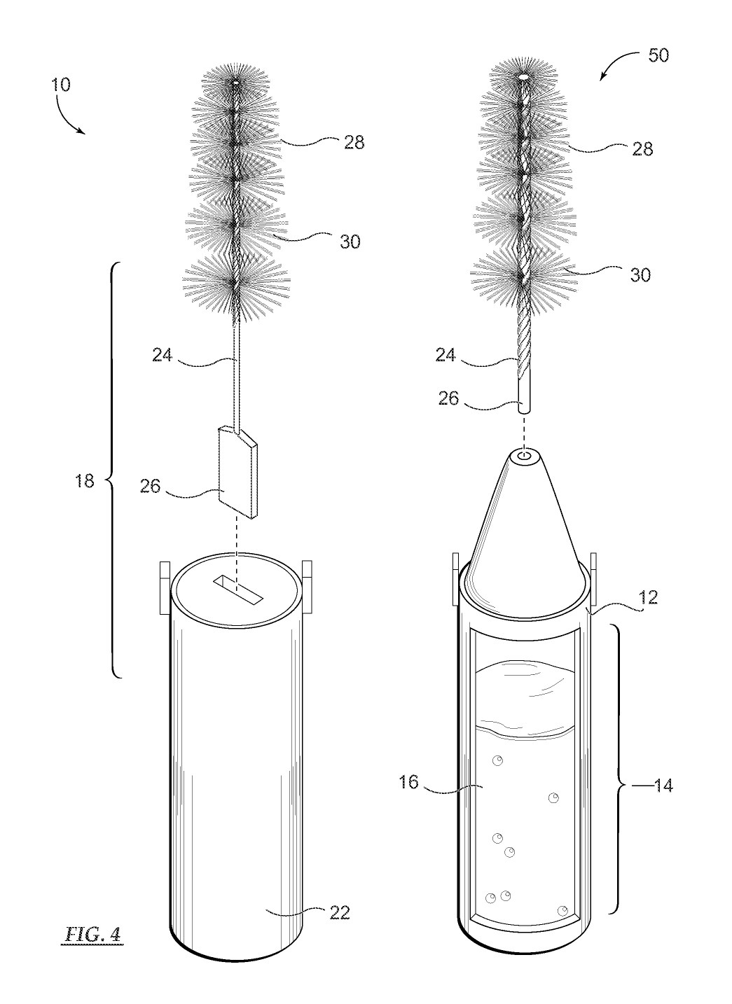

FIG. 4 illustrates the capability of being able to remove the applicator 20 from the body 12 or cap 22. The removable feature allows the user to remove an “old” applicator 20 and insert a “new” applicator 20. The new applicator 20 may be necessary because the old applicator 20 is worn or the user requires an application end 28 with different application properties. For example, a brush can have various configurations, stiffness, sizes, or bristle properties.

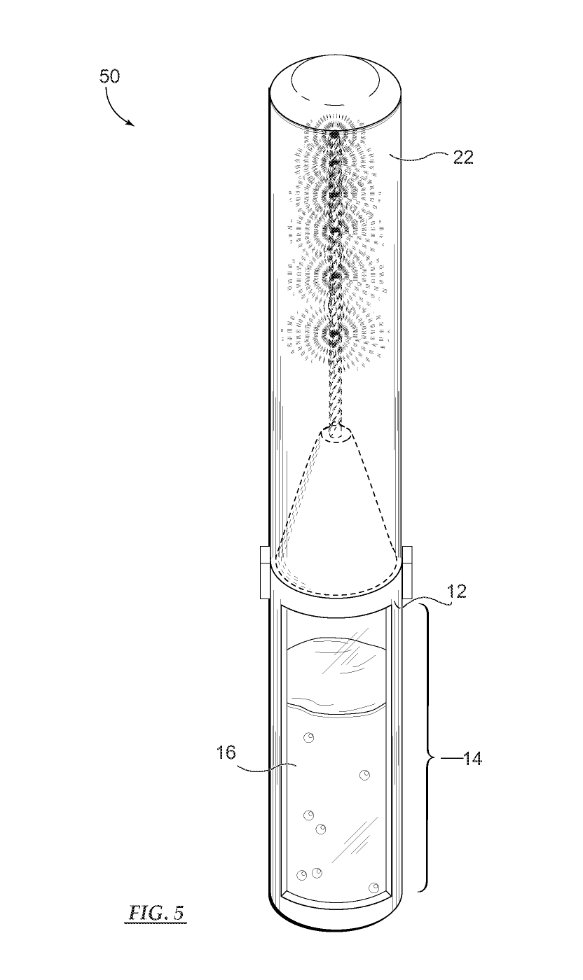

FIG. 5 illustrates the device 10 in a closed position or with the cap 22 attached to the body 12. When not in use, the device 10 is in a closed configuration. The applicator 20 will remain clean and the oral cleaner 16 in the reservoir 14 will not spill or evaporate. Over time, the effectiveness of the oral cleaner 16 will decrease. The user can either refill the reservoir 14 with new solution or paste or alternatively begin using a new device 10 or 50.

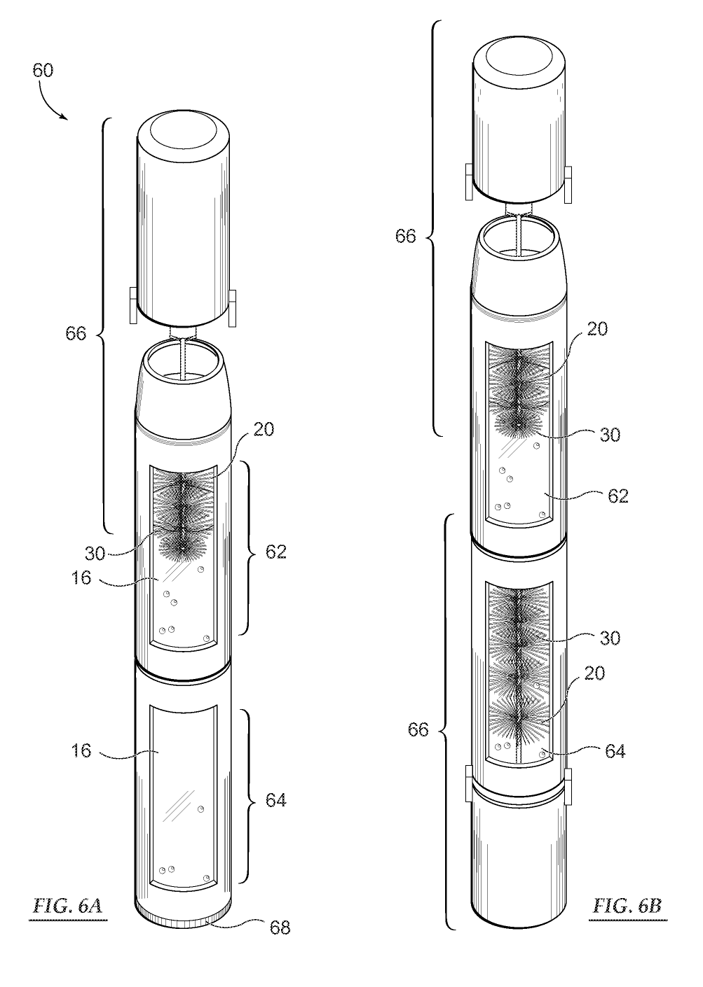

As illustrated in FIG. 6A, the device 60 can also be configured with a first reservoir 62 and a second reservoir 64. The first reservoir 62 can contain a different oral cleaner 16 than that in the second reservoir 64. The oral device 60 has one applicator assembly 66 removably attached to the body. The reservoir that does not have the applicator assembly 66 inserted has lid 68 to cover the opening. In a preferred embodiment as shown in FIG. 6B, the oral hygiene device 60 having two reservoirs, can also have two applicator assemblies 66. Optionally, the first reservoir 62 and second reservoir 64 can contain different oral cleaners 16 and each applicator assembly 66 can have a different applicator 20. For example, one applicator 20 can be an interdental brush and the other applicator can be a sponge.

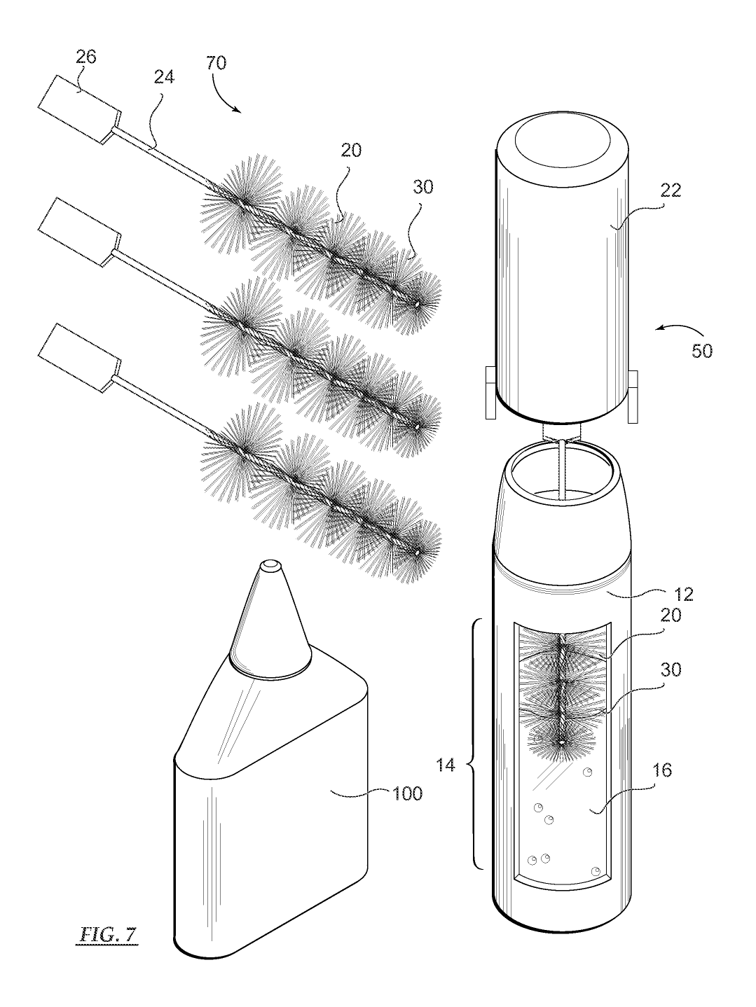

The device 10, 50, 60 and its parts can be included in a system 70 as demonstrated in FIG. 7. The system 70 comprises a device as illustrated in FIGS. 1, 2 3, and 6, extra applicators 20 and an oral cleaning solution, paste or combinations thereof 100.

For the device 10, illustrated in FIGS. 1 and 6, the user removes the applicator 20 from the body 12 by disengaging the cap 22. The applicator 20 will then be coated with the oral cleaner 16 from the reservoir 14. The user will insert the application end 28 between and through the teeth and gums. The user can brush between the teeth by pulling the application end 28 through the small interdental spaces between the gum lines. When pulled, the application end 28, which is spongy in nature, slips though the much smaller spaces. When the device 50 is configured as illustrated in FIGS. 2 and 3, the user removes the cap 22, squeezes the body 12 to release to oral cleaner 16 from the reservoir 14. Applies the application end 29 of the applicator 20 to the oral area. When finished, the user replaces the cap 22 securely on the body 12.

### Materials and Methods

Methods and materials are described herein. However, methods and materials similar or equivalent to those described herein can be also used to obtain variations of the present invention. The materials, methods, and examples are illustrative only and not intended to be limiting.

### INCORPORATION BY REFERENCE

Throughout this application, various publications, patents, and/or patent applications are referenced in order to more fully describe the state of the art to which this invention pertains. The disclosures of these publications, patents, and/or patent applications are herein incorporated by reference in their entireties, and for the subject matter for which they are specifically referenced in the same or a prior sentence, to the same extent as if each independent publication, patent, and/or patent application was specifically and individually indicated to be incorporated by reference.

### OTHER EMBODIMENTS

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An oral hygiene device comprising:
a) a body comprising an open end, a closed end and a reservoir, wherein the reservoir comprises an oral cleaner; and
b) an applicator assembly, comprising a cap removably attached to the body so that the cap ensures closure of the body and an applicator connected to the cap by an axial rod.

2. The oral hygiene device of claim 1, wherein the reservoir is contained within the body, the reservoir comprising an open end and a closed end coincident with the body.

3. The oral hygiene device of claim 1, wherein the applicator assembly further comprises a bristle portion wherein the bristle portion is 0.2 mm to 5.0 mm.

4. The oral hygiene device of claim 1, wherein the applicator is an interdental brush.

5. The oral hygiene device of claim 1, wherein the oral cleaner is a solution, a paste or combinations thereof.

6. The oral hygiene device of claim 1, wherein the oral cleaner is a medicament.

7. An oral hygiene device comprising:
a) a body comprising an open end, a closed end and a reservoir, wherein the reservoir comprises an oral cleaner;
b) a hollow axial rod having a proximal end and a distal end, the distal end configured to receive the oral cleaner from the reservoir and the proximal end having an applicator; and
c) a cap sized and dimensioned to fit over the applicator to securely engage the body.

8. The oral hygiene device of claim 7, wherein the applicator is an interdental brush.

9. The oral hygiene device of claim 7, wherein the oral cleaner is a solution, a paste or both.

10. The oral hygiene device of claim 7, wherein the oral cleaner is a medicament.

11. An oral hygiene device comprising:
a) a body, comprising a first reservoir and a second reservoir contained with body, the first reservoir and second reservoir comprising an open end and a closed end coincident with the body;
b) an applicator assembly comprising a cap, removably attached to the body so that the cap ensures closure of the body and an applicator connected to the cap by an axial rod; and
c) a lid for covering the second reservoir.

12. The oral hygiene device of claim 11, wherein the applicator is an interdental brush.

13. The oral hygiene device of claim 11, wherein the reservoir further comprises an oral cleaner.

14. The oral hygiene device of claim 13, wherein the oral cleaner is a solution, a paste or both.

15. The oral hygiene device of claim 11, wherein the oral cleaner is a medicament.

16. An oral hygiene device comprising:
a) a body comprising a first reservoir and a second reservoir contained with body, the first reservoir and second reservoir comprising an open end and a closed end coincident with the body; and
b) a first applicator assembly and a second applicator assembly, the first applicator assembly and second applicator assembly comprising a cap removably attached to the body so that the cap ensures closure of the body and an applicator connected to the cap by an axial rod.

17. The oral hygiene device of claim 16, wherein the applicator is an interdental brush.

18. The oral hygiene device of claim 16, wherein the reservoir further comprises an oral cleaner.

19. The oral hygiene device of claim 18, wherein the oral cleaner is a solution, a paste or both.

20. A method for cleaning oral cavity, the method comprising the steps of:
a) providing a user with a device of claim 1;
b) removing the applicator assembly from the body;
c) applying the applicator assembly to the oral cavity; and
d) securing the applicator assembly to the body.

21. A method for cleaning oral cavity, method comprising the steps of:
a) providing a user with a device of claim 7;
b) removing the applicator assembly from the body;
c) applying the applicator assembly to the oral cavity; and
d) securing the applicator assembly to the body.

22. A method for cleaning oral cavity, the method comprising the steps of:
a) providing a user with a device of claim 11;
b) removing the applicator assembly from the body;
c) applying the applicator assembly to the oral cavity; and
d) securing the applicator assembly to the body.

23. A method for cleaning oral cavity, the method comprising the steps of:
a) providing a user with a device of claim 16;
b) removing the applicator assembly from the body;
c) applying the applicator assembly to the oral cavity; and
d) securing the applicator assembly to the body.

24. An oral cleaning system comprising:
a) the device of claim 1;
b) one or more than one applicators; and
c) an oral cleaning solution.

25. An oral cleaning system comprising:
a) the device of claim 7;
b) one or more than one applicators; and
c) an oral cleaning solution.

26. An oral cleaning system comprising:
a) the device of claim 11;
b) one or more than one applicators; and
c) an oral cleaning solution.

27. An oral cleaning system comprising:
a) the device of claim 16;
b) one or more than one applicators; and
c) an oral cleaning solution.
